(19) United States
(12) Patent Application Publication
(10) Pub. No.: US 2025/0041839 A1
(43) Pub. Date: Feb. 6, 2025

(54) CATALYTICALLY ACTIVE PARTICLE FILTER WITH A HIGH DEGREE OF FILTRATION EFFICIENCY

(71) Applicant: UMICORE AG & CO. KG, Hanau-Wolfgang (DE)

(72) Inventors: Jan SCHOENHABER, Darmstadt (DE); Gabriela KUCEROVA, Senden (DE); Naina DEIBEL, Pfungstadt (DE); Meike Antonia GOTTHARDT, Frankfurt (DE)

(73) Assignee: UMICORE AG & CO. KG, Hanau-Wolfgang (DE)

(21) Appl. No.: 18/696,432

(22) PCT Filed: Sep. 30, 2022
(86) PCT No.: PCT/EP2022/077268

§ 371 Date: Mar. 28, 2024

(30) Foreign Application Priority Data
Oct. 1, 2021 (DE) 10 2021 125 536.8

(51) Int. Cl. B01J 35/00; B01D 53/94; B01J 23/00; B01J 23/46; B01J 23/63; B01J 35/56; F01N 3/035

(52) U.S. Cl. CPC B01J 35/19; B01D 53/94; B01J 23/002; B01J 23/464; B01J 23/63; B01J 35/56; F01N 3/035; B01D 2255/1023; B01D 2255/1025; B01D 2255/2061; B01D 2255/2063; B01D 2255/2065; B01D 2255/2066; B01D 2255/20715; B01D 2255/2073; B01D 2255/2092; B01D 2255/407; B01D 2255/9032; B01D 2255/9155; B01D 2258/01; B01J 2523/3712; B01J 2523/3718; B01J 2523/72; F01N 2510/063; F01N 2510/0684

(57) ABSTRACT

The invention relates to a wall flow filter for removing particulate matter from the exhaust of internal combustion engines, comprising a wall flow filter substrate having a length L, and a coating F, the wall flow filter substrate being provided with channels E and A which run parallel between a first end and a second end of the wall flow filter substrate, separated by porous walls, and forming surfaces O_{E} and O_{A}. Channels O_{E} are closed at the second end and channels A are closed at the first end. Coating F is disposed in the porous walls and/or on surfaces O_{E}, but not on surfaces O_{A}, and comprises a particulate metal compound and no precious metal, characterised in that the particulate metal compound catalyses the oxidation of soot.

The present invention relates to a wall-flow filter, to a method for the production thereof and the use thereof for reducing harmful exhaust gases of an internal combustion engine.

The emission of pollutants and particles in exhaust gases of internal combustion engines is generally subject to legal limits. For example, an additional limit for limiting the number of particles was implemented with EU6 exhaust gas standard for gasoline direct injection engines.

Diesel particulate filters or gasoline particulate filters with and without an additional catalytically active coating are suitable aggregates for removing particle emissions and reducing harmful substances in exhaust gases. These are wall-flow honeycomb bodies, which are referred to as catalyst supports, carriers or substrate monoliths. In order to meet the legal standards, it is desirable for current and future applications for the exhaust gas aftertreatment of internal combustion engines to combine particulate filters with other catalytically active functionalities not only for reasons of cost but also for installation space reasons. The catalytically active coating can be located on the surface or in the walls of the channels forming this surface. The catalytically active coating is often applied to the catalyst support in the form of a suspension in a so-called coating operation. Many such processes have been published in the past by automotive exhaust-gas catalyst manufacturers; see, for example, EP1064094B1, EP2521618B1, WO10015573A2, EP1136462B1, U.S. Pat. No. 6,478,874B1, U.S. Pat. No. 4,609,563A, WO9947260A1, JP5378659B2, EP2415522A1, and JP2014205108A2.

The use of a particulate filter, whether catalytically coated or not, leads to a noticeable increase in the exhaust-gas back pressure in comparison with a flow-through support of the same dimensions and thus to a reduction in the torque of the engine or possibly to increased fuel consumption. In order to not increase the exhaust-gas back pressure even further, the amounts of oxidic support materials for the catalytically active noble metals of the catalyst or oxidic catalyst materials are generally applied in smaller quantities in the case of a filter than in the case of a flow-through support. As a result, the catalytic effectiveness of a catalytically coated particle filter is frequently inferior to that of a flow-through monolith of the same dimensions.

There have already been some efforts to provide particulate filters that have good catalytic activity due to an active coating and yet have the lowest possible exhaust-gas back pressure. With regard to a low exhaust-gas back pressure, it has proven to be expedient if the catalytically active coating is not present as a layer on the channel walls of a porous wall-flow filter, but the channel walls of the filter are instead interspersed with the catalytically active material; see, for instance, WO2005016497A1, JPH01-151706, and EP1789190B1. For this purpose, the particle size of the catalytic coating is selected such that the particles penetrate into the pores of the wall-flow filters and can be fixed there by calcination. A disadvantage of catalytically active filters having an in-wall coating is that the amount of catalytically active substance is limited by the absorption capacity of the porous wall.

It has been found that, by applying the catalytically active substances to the surfaces of the channel walls of a wall-flow honeycomb body, an increase in the conversion of the harmful substances in the exhaust gas can be achieved. Combinations of on-wall coating and in-wall coating with catalytically active material are also possible, as a result of which the catalytic performance can be further increased without substantially increasing the back pressure.

In addition to the catalytic effectiveness, a further functionality of the filter that can be improved by a coating is its filtration efficiency, i.e., the filtering effect itself. WO2011151711A1 describes a method by means of which a dry aerosol is applied to a non-coated or catalytically coated filter that carries the catalytic active material in the channel walls (in-wall coating with a washcoat). The aerosol is provided by the distribution of a powdered high-melting metal oxide and is guided through the inlet side of a wall-flow filter by means of a gas stream. In this case, the individual particles having a particle size of 0.2 μm to 5 μm agglomerate to form a bridged network of particles and are deposited as a layer on the surface of the individual inlet channels passing through the wall-flow filter. The typical powder loading of a filter is between 5 g and 50 g per liter of filter volume. It is expressly pointed out that it is not desirable to obtain a coating inside the pores of the wall-flow filter with the metal oxide.

A further method for increasing the filtration efficiency of catalytically inactive filters is described in WO2012030534A1. In this case, a filtration layer (“discriminating layer”) is created on the walls of the flow channels of the inlet side by the deposition of ceramic particles via a particle aerosol. The layers consist of oxides of zirconium, aluminum, or silicon, preferably in fiber form ranging from 1 nm to 5 μm in length, and have a layer thickness greater than 10 μm, typically 25 μm to 75 μm. After the coating process, the applied powder particles are calcined in a thermal process.

A further method in which a membrane (“trapping layer”) is produced on the surfaces of the inlet channels of filters in order to increase the filtration efficiency of catalytically inactive wall-flow filters is described in patent specification U.S. Pat. No. 8,277,880B2. The filtration membrane on the surfaces of the inlet channels is produced by sucking through a gas stream loaded with ceramic particles (for example, silicon carbide or cordierite). After application of the filter layer, the honeycomb body is fired at temperatures greater than 1000° C. in order to increase the adhesive strength of the powder layer on the channel walls. EP2502661A2 and EP2502662B1 mention further on-wall coatings by powder application.

Coating inside the pores of a wall-flow filter substrate by spraying dry particles is described in U.S. Pat. No. 8,388,721 B2. In this case, however, the powder should penetrate deeply into the pores. 20% to 60% of the surface of the wall should remain accessible to soot particles, thus open. Depending on the flow velocity of the powder-gas mixture, a more or less steep powder gradient between the inlet and outlet sides can be adjusted. The pores of the channel walls of the filter coated with powder in the pores according to U.S. Pat. No. 8,388,721 B2 can subsequently be coated with a catalytically active component. Here as well, the catalytically active material is located in the channel walls of the filter.

The introduction of the powder into the pores, for example by means of an aerosol generator, is also described in EP2727640A1. Here, a non-catalytically coated wall-flow filter is coated using a gas stream containing, for example, aluminum oxide particles in such a way that the complete particles, which have a particle size of 0.1 μm to 5 μm, are deposited as a porous filling in the pores of the wall-flow filter. The particles themselves can realize a further functionality of the filter in addition to the filtering effect. For example, these particles are deposited in the pores of the filter in an amount greater than 80 g/l based on the filter volume. They fill 10% to 50% of the volume of the filled pores in the channel walls. This filter, both loaded with soot and without soot, has an improved filtration efficiency compared to the untreated filter together with a low exhaust-gas back pressure of the soot-loaded filter.

In WO2018115900A1, wall-flow filters are coated with an optionally dry synthetic ash in such a way that a continuous membrane layer is formed on the walls of the optionally catalytically coated wall-flow filter.

All of said prior art patent documents have the aim of increasing the filtration efficiency of a filter by coating the filter with a powder. The filters optimized in this way can also carry a catalytically active coating in the porous channel walls before the powder coating. However, there are no indications in any of the examples to simultaneously optimize the catalytic effect of a filter and increase filtration efficiency.

Soot particles are retained by the filter effect of the filter and accumulated on the filter wall. This can lead to a further increase in the exhaust gas counterpressure beyond the increase thereof caused by the reasons already described above. In order to counteract this, the filter is generally regenerated continuously or periodically, i.e., the accumulated soot particles are burned off. For this purpose, filters for cleaning diesel exhaust gas often carry a soot oxidation catalyst which is able to reduce the soot ignition temperature. Thus, wall-flow filters coated with platinum group metals, in particular with platinum, are in use and known under the designation cDPF or CSF. However, cerium oxide, cerium-zirconium mixed oxides and cerium oxide doped with copper, iron or manganese, for example, have also already been described for this purpose; see, for example, WO2010002486A2, WO2012135871A1 and WO20170556810A1.

There continues to be a need for particulate filters with which both catalytic activity and filtration efficiency are optimized with respect to exhaust-gas counterpressure and which have improved soot combustion properties.

The object of the present invention is to provide a corresponding particulate filter with which sufficient filtration efficiency is coupled with the lowest possible increase in exhaust-gas counterpressure and high catalytic activity, also with respect to soot combustion.

These and other objects which are obvious from the prior art are achieved by a particulate filter according to claims 1 to 13. Claim 14 is directed to the production of a particulate filter according to the invention. Claim 15 is directed to the use of the particulate filter for the aftertreatment of internal combustion engine exhaust gases.

The present invention relates to a wall-flow filter for removing particles from the exhaust gas of combustion engines, comprising a wall-flow filter substrate of length L and a coating F,

the wall-flow filter substrate having channels E and A, which extend in parallel between a first and a second end of the wall-flow filter substrate, are separated by porous walls and form surfaces O_{E} and O_{A} respectively, and the channels E being closed at the second end and the channels A are closed at the first end,
and the coating F being located in the porous walls and/or on the surfaces O_{E}, but not on the surfaces O_{A}, and comprising a particulate metal compound and no noble metal,
characterized in that the particulate metal compound catalyzes the oxidation of soot.

When the wall-flow filter according to the invention is used as intended for cleaning exhaust gas of internal combustion engines, the exhaust gas flows into the filter at one end and leaves it again after passing through the porous walls at the other end. Therefore, if the exhaust gas enters the filter at the first end, for example, the channels E denote the inlet channels or inflow-side channels. After passing through the porous walls, it then exits the filter at the second end, such that the channels A denote the outlet channels or outflow-side channels.

All ceramic wall-flow filter substrates known from the prior art and customary in the field of automobile exhaust gas catalysis can be used as wall-flow substrates. Porous wall-flow filter substrates made of cordierite, silicon carbide, or aluminum titanate are preferably used. These wall-flow filter substrates have channels E and channels A which, as described above, act as inlet channels, which can also be called inflow channels, and as outlet channels, which can also be called outflow channels. The outflow-side ends of the inflow channels and the inflow-side ends of the outflow channels are closed off from one another in an offset manner with generally gas-tight “plugs”. In this case, the exhaust gas that is to be purified and that flows through the filter substrate is forced to pass through the porous wall between the inflow channel and outflow channel, which brings about a particulate filtering effect. The filtration property for particulates can be designed by means of the porosity, pore/radii distribution, and thickness of the wall. According to the invention, the porosity of the uncoated wall-flow filter substrates is typically more than 40%, for example from 40% to 75%, particularly from 50% to 70% [measured according to DIN 66133, latest version on the filing date]. The average pore size d₅₀ of the uncoated wall-flow filter substrates is at least 7 μm, for example from 7 μm to 34 μm, preferably more than 10 μm, in particular more preferably from 10 μm to 25 μm or most preferably from 15 μm to 20 μm [measured according to DIN 66134, latest version on the filing date], wherein the d₅₀ value of the pore size distribution of the wall-flow filter substrate is to be understood to mean that 50% of the total pore volume determinable by mercury porosimetry is formed by pores whose diameter is less than or equal to the value specified as d₅₀. In the case of the wall-flow filters according to the invention, the wall-flow filter substrates provided with the coating F and optionally coating Z (see below) particularly preferably have a pore size of from 5 μm to 20 μm and a porosity from 50% to 65%.

According to the invention, coating F comprises a particulate metal compound which catalyzes the oxidation of soot. It is thus catalytically active within the meaning of the present invention (see further below).

In addition to the catalytically active particulate metal compound, coating F can also contain further particulate metal compounds which are not catalytically active. In addition to the catalytically active particulate metal compounds and optionally catalytically inactive particulate metal compounds, coating F preferably does not contain any further constituents.

Metal compounds which catalyze the oxidation of soot are in particular high-melting metal compounds, such as metal oxides, metal sulfates, metal phosphates, metal carbonates or metal hydroxides or mixtures thereof. Particular preference is given to metal oxides which are in particular binary or ternary metal oxides, or mixtures thereof.

Binary or ternary metal oxides are in particular selected from the group consisting of AOₓ, A₂O₃, A₃O₄, ABOₓ, AB₂Oₓ, A₂B₂O_{x, x} and A₂BOₓ, wherein A and B are different metals and x assumes a value which ensures corresponding electroneutrality in the corresponding oxide.

The metals A and B are in particular selected from the group consisting of silicon, aluminum, titanium, zirconium, cerium, iron, zinc, copper cobalt, magnesium, potassium barium strontium, calcium, manganese, bismuth vanadium, ruthenium, osmium, rhenium, nickel, lanthanum, praseodymium, tin and yttrium.

Very particularly preferred metal oxides are MnO₂, Mn₂O₃, CePrOₓ, CuO.

Furthermore, within the meaning of the present invention, the particulate metal compound can be a mixed oxide and, in addition to cerium, can contain at least one further metal from the group of aluminum, zirconium, iron, zinc, copper, cobalt, barium, strontium, calcium, potassium, manganese, lanthanum, praseodymium and yttrium.

In addition, oxides are preferably those that satisfy the formula Pr₂₋ₓAₓCe_{2-Y}B_{Y}O_{z}, wherein A is an alkaline earth metal or an alkali metal or a transition metal and is selected from the group of Mg, Ca, Sr, Ba, K, Cs, La, Bi, Y and Zn, and B is a transition metal that differs from A, selected from the group of Sn, Zr, Ti, Fe, Mn, Al, Ga, Bi, Ni, Co, Cu. X and Y may assume values of 0-1, wherein X and/or Y>0 and Z has a value which leads to the electroneutrality of the oxide. X particularly preferably assumes a value of 0.05-0.5. Y particularly preferably assumes a value of 0.05 to 0.5.

In addition, so-called pyrogenic metal oxides can also be used. In general, pyrogenically produced metal oxides are understood to be those obtained by flame hydrolysis or flame oxidation from a metal oxide precursor in an oxyhydrogen flame (https://de.wikipedia.org/w/index.php?title=Pyrogenes_Siliciumdioxid&oldid=182147815; Pater Albers et al. Chemie in unserer Zeit [Chemistry in our Time], 2016, 50, 162-171; Hans Ferkel et al. MTZ—Motortechnische Zeitschrift [Engine Technology Magazine], 2010, 71, 128-133). These have properties as described for flame-synthesized particulate products in the following references, Gutsch et al. (2002) KONA (no. 20); Li S. et al. (2016) Progress in Energy and Combustion Science (55); Ulrich G. (1971) Combustion Science and Technology (vol. 4). Pyrogenic metal oxides are generally characterized by a high specific surface area and a low bulk density. Generally, large-surface oxides of different metals can be produced by means of this method. Such oxides are advantageously produced from the group of metals consisting of silicon, aluminum, titanium, zirconium, cerium or mixtures of such metals.

The wall-flow filter according to the invention can have an increasing concentration gradient of the coating F in the longitudinal direction of the filter from its first to the second end. According to the invention, the term “increasing gradient” refers to the fact that the gradient of the concentration of the coating F in the filter increases in the axial direction from one end to the other, possibly from negative values to more positive values.

In the case of an intended use of the wall-flow filter in which the exhaust gas flows in at its first end and out at the second end, a larger amount of coating F is preferably located near the second end of the wall-flow filter substrate and a significantly smaller amount of coating F is located near the first end of the wall-flow filter substrate.

Simulations of the gas flow in a wall-flow filter have shown that the last third of the substrate is mainly (more than 50%) responsible for the filtration property of the overall filter. An increased application of a coating F on the last third of the filter additionally increases the back pressure there, this being due to the lower permeability, and the throughflow shifts more into the first two thirds of the filter. The filter should therefore have a gradient of the coating F which increases more strongly from the input towards the output in order to increase its filtration effect. This applies mutatis mutandis to the adjustment of an advantageous exhaust-gas back pressure. Accordingly, if necessary, a gradient of the concentration of coating F that increases less rapidly should be selected here.

The coating F is preferably located in the porous walls of the wall-flow filter substrate, from which it follows that the particle size of the metal compound must be adapted to the pore size of the wall-flow filter substrate. The particles of the metal compound thus have in particular a defined particle size distribution.

Since wall-flow filter substrates usually contain pores of different sizes, a proportion of larger particles is ideally present for the large pores and a proportion of smaller particles for the smaller pores. This means that the metal compound preferably has a multimodal or broad q3 particle size distribution. According to the invention, coating F can, however, also be located on the porous walls O_{E} or partially in the porous walls and partially on the porous walls O_{E} but not on the walls O_{A}.

For the definition of the particle size or grain size distribution of the metal compound, a distinction is made, depending on the method by which the quantity of particles is determined, among other things between number-related (q0) and volume-related (q3) grain size distributions (M. Stieß, Mechanische Verfahrenstechnik—Partikeltechnologie 1 (Mechanical Process Technology—Particle Technology 1), Springer, 3rd edition 2009, page 29).

Here, the size of the coarse particles (defined by the d90 value of the q3 grain size distribution, measured with the Tornado dry dispersion module by Beckmann according to the most recent ISO 13320-1 on the date of application) of the metal compound should be less than or equal to 60% of the average volume-related q3 pore size (d50) of the filter used (measured according to DIN 66134, latest version on the date of application), preferably less than 50%. The average q3 grain size of the metal compound (d50) should be 5% to 30% of the average q3 pore size (d50) of the filter used, preferably 7% to 25%, and very preferably 10% to 25%. The d10 value of the q3 grain size distribution of the metal compound, which describes the fine fraction, should be 20% to 60% of the average q3 grain size (d50) of the metal compound, preferably 25% to 50%, and particularly preferably 25% to 40%. The d10 value of the number-related q0 grain size distribution should generally be higher than 0.05 μm, preferably higher than 0.08 μm, and particularly preferably higher than 0.1 μm.

The particles of the metal compound have in particular a total surface area of greater than 5 m²/l, preferably greater than 10 m²/l and very particularly preferably greater than 15 m²/l, based on the outer filter volume in liters.

The total surface area of the particles SV is obtained from the particle size x according to:

$${S}_{v} [ {m}^{- 1} ] = 6 \cdot {\int }_{x \_ min}^{x \_ max} {x}_{i}^{- 1} \cdot {q}_{0} ( {x}_{i} ) \cdot dx = 6 \cdot {\sum }_{min}^{max} \frac{Δ {Q}_{3} ( {x}_{i} )}{{x}_{i}}$$

(M. Stieß, Mechanische Verfahrenstechnik—Partikeltechnologie 1 [Mechanical Process Engineering—Particle Technology 1], Springer, 3rd edition, 2009, page 35), and the mass-related surface (M. Stieß, Mechanische Verfahrenstechnik—Partikeltechnologie 1, Springer, 3rd edition, 2009, page 16) is obtained therefrom with the density of the particles ρ:

$${S}_{m} [ \frac{{m}^{2}}{kg} ] = \frac{{S}_{V}}{{ρ}_{particles}}$$

outer surface of the powder Sₒᵤₜₑᵣ[m²]=Sₘ·m_{powder}

A person skilled in the art can easily determine the particle size distribution and the total surface area of the metal compound of a finished wall-flow filter according to the invention by washing the metal compound out of the wall-flow filter substrate with water. He/she only has to collect the washed-out material, dry it and then determine the desired parameters using the methods known to him/her or mentioned above.

In particular, a portion of the coating F can also be formed on the surface O_{E} as a result of the production process. In particular, 1 to 90% of the total mass of the coating F can be located on the surface O_{E}, but preferably 2 to 70% and particularly preferably 3 to 50%.

The coating F preferably does not form a coherent, continuous layer on the surface O_{E}, but selectively clogs the large pores of the wall-flow substrate, resulting in an island-like deposition pattern.

The coating F can be wholly or partially present as a closed layer on the surfaces O_{E}. In this case, the layer thickness of the coating F is generally 1 to 75 μm, but preferably 5 to 65 μm.

In an embodiment according to the invention in which the coating Z is located on the surfaces O_{A}, the layer thickness of the coating F is less than or equal to the layer thickness of the coating Z. The ratio of the layer thickness of the coating F to the layer thickness of the coating Z is preferably 0.1 to 1, more preferably 0.15 to 0.95 and particularly preferably 0.2 to 0.9. Furthermore, the average particle diameter d₅₀ of the oxides of coating F is smaller than or equal to the average particle diameter d₅₀ of the coating Z. Preferably, the ratio of the d₅₀ of the particles of coating F to the d₅₀ of the particles of coating Z is 0.01 to 1, preferably 0.05 to 0.9 and particularly preferably 0.15 to 0.8.

In an embodiment according to the invention in which the coating Z is located in the pores of the filter wall, the layer thickness of the coating F is greater than or equal to the layer thickness of the coating Z. Furthermore, the average particle diameter d₅₀ of the oxides of coating F is greater than or equal to the average particle diameter d₅₀ of the coating Z. Preferably, the ratio of the d₅₀ of the particles of coating F to the d₅₀ of the particles of coating Z is 1 to 7, preferably 1.05 to 6 and particularly preferably 1.1 to 5.

Based on the volume of the wall-flow filter substrate, coating F is present, for example, in amounts of less than 50 g/l, in particular of less than 40 g/l. The coating F is preferably present in amounts from 2.5 to 40 g/l based on the volume of the wall-flow filter substrate.

The coating F may extend over the entire length L of the wall-flow filter substrate or only over a portion thereof. For example, coating F extends over 10 to 100, 25 to 80 or 40 to 60% of the length L.

In one embodiment of the wall-flow filter according to the invention, the wall-flow filter substrate comprises a coating Z which is located in the porous walls and/or on the surfaces O_{A}, but not on the surfaces O_{E}, and comprises palladium and/or rhodium and a cerium-zirconium mixed oxide.

If the coating Z is located on the surfaces O_{A} of the wall-flow filter substrate, it preferably extends from the second end of the wall-flow filter substrate to 50 to 90% of the length L.

The coating on the surfaces O_{A} is a so-called on-wall coating. This means that the coating rise above the surfaces O_{A} into the channels A of the wall-flow filter substrate, thus reducing the channel cross section. In this embodiment, the pores of the porous wall which are adjacent to the surfaces O_{A} are filled with the coating Z only to a minor extent. More than 80%, preferably more than 90%, of the coating Z is not located in the porous wall.

If the coating Z is located in the porous walls of the wall-flow filter substrate, it preferably extends from the first end of the wall-flow filter substrate to 50 to 100% of the length L.

The coating of the porous walls is a so-called in-wall coating. In this embodiment, the surfaces O_{A} adjacent to the porous walls are coated with the coating Z only to a minor extent.

The minimum length of the coating Z is at least 1.25 cm, preferably at least 2.0 cm and most preferably at least 2.5 cm, calculated from the second end of the wall-flow filter substrate.

In a further preferred embodiment, the coating Z has a thickness gradient over the length L such that the thickness of the coating Z increases along the length L of the wall-flow filter. In this case, the coating may preferably have more than 2 times, more preferably up to more than 3 times the thickness at one coating end than the other coating end. In this case, the thickness is the height at which the coating Z rises above the surface O_{A}. The thickness gradient of the coating on the channel walls also makes it possible for the filtration efficiency to be adjusted over the entire length L of the filter. The result is a more uniform deposition of the soot over the entire filter wall and thus an improved exhaust-gas back pressure increase and possibly a better burn-off of the soot.

The coating Z is a catalytically active coating in particular due to the constituents palladium and/or rhodium. In the context of the present invention, “catalytically active” is understood to mean the ability to convert harmful constituents of the exhaust gas from internal combustion engines into less harmful ones. In particular, the exhaust gas components NOx, CO and HC are of note here with respect to coating F on particles. Consequently, coating Z is particularly preferably three-way catalytically active, in particular at operating temperatures of 250 to 1100° C.

Coating Z contains the noble metals palladium and/or rhodium, with platinum also being present as a further noble metal only in exceptional cases. Particularly preferably, coating Z contains palladium and rhodium and no platinum.

In a further embodiment, coating Z contains the noble metals platinum and/or rhodium, with palladium also being present as a further noble metal only in exceptional cases.

In a further embodiment, coating Z contains the noble metals platinum, palladium and/or rhodium. In this embodiment, it is advantageous if the mass ratio of platinum to palladium is 15:1 to 1:15, in particular 10:1 to 1:10.

Based on the particulate filter according to the invention, the proportion of rhodium in the entire noble metal content is in particular greater than or equal to 5% by weight, preferably greater than or equal to 10% by weight. For example, the proportion of rhodium in the total noble metal content is 5 to 20% by weight or 5 to 15% by weight. The noble metals are usually used in quantities of 0.10 to 5 g/l based on the volume of the wall-flow filter substrate.

The noble metals are usually fixed on one or more carrier materials. All materials that are familiar to the person skilled in the art for this purpose are considered as support materials. Such materials are in particular metal oxides with a BET surface area of 30 to 250 m²/g, preferably 100 to 200 m²/g (determined according to DIN 66132, latest version as of filing date). Particularly suitable carrier materials for the noble metals are selected from the series consisting of alumina, doped alumina, silicon oxide, titanium dioxide and mixed oxides of one or more thereof. Doped aluminum oxides are, for example, aluminum oxides doped with lanthanum oxide, zirconium oxide, barium oxide and/or titanium oxide. Aluminum oxide or lanthanum-stabilized aluminum oxide is advantageously used, wherein lanthanum is used in quantities of 1 to 10% by weight, preferably 3 to 6% by weight, in each case calculated as La₂O₃ and based on the weight of the stabilized aluminum oxide.

Also in the case of aluminum oxide doped with barium oxide, the proportion of barium oxide is in particular 1 to 10% by weight, preferably 3 to 6% by weight, in each case calculated as BaO and based on the weight of the stabilized aluminum oxide.

Another suitable carrier material is lanthanum-stabilized aluminum oxide the surface of which is coated with lanthanum oxide, with barium oxide and/or with strontium oxide.

Coating Z preferably comprises at least one aluminum oxide or doped aluminum oxide.

Coating Z contains at least one cerium-zirconium mixed oxide that acts as an oxygen storage component. The mass ratio of cerium oxide to zirconium oxide in these products can vary within wide limits. It is, for example, 0.1 to 1.5, preferably 0.15 to 1 or 0.2 to 0.9.

Preferred cerium-zirconium mixed oxides comprise one or more rare earth metal oxides and can thus be referred to as cerium-zirconium-rare earth metal mixed oxides. The term “cerium-zirconium-rare-earth metal mixed oxide” within the meaning of the present invention excludes physical mixtures of cerium oxide, zirconium oxide, and rare earth oxide. Rather, “cerium-zirconium-rare earth metal mixed oxides” are characterized by a largely homogeneous, three-dimensional crystal structure that is ideally free of phases of pure cerium oxide, zirconium oxide or rare earth oxide (solid solution). Depending on the manufacturing process, however, not completely homogeneous products may arise which can generally be used without any disadvantage. The same applies to cerium-zirconium mixed oxides which do not contain any rare earth metal oxide. In all other respects, the term “rare earth metal” or “rare earth metal oxide” within the meaning of the present invention does not include cerium or cerium oxide.

Lanthanum oxide, yttrium oxide, praseodymium oxide, neodymium oxide and/or samarium oxide can, for example, be considered as rare earth metal oxides in the cerium-zirconium-rare earth metal mixed oxides. Lanthanum oxide, yttrium oxide and/or praseodymium oxide are preferred. Lanthanum oxide and/or yttrium oxide are particularly preferred, and lanthanum oxide and yttrium oxide, yttrium oxide and praseodymium oxide, and lanthanum oxide and praseodymium oxide are more particularly preferred. In embodiments of the present invention, the oxygen storage components are free of neodymium oxide.

The proportion of rare earth metal oxide in the cerium-zirconium-rare earth metal mixed oxides is in particular 3 to 20% by weight based on the cerium-zirconium-rare earth metal mixed oxide.

If the cerium-zirconium-rare earth metal mixed oxides contain yttrium oxide as a rare earth metal, the proportion thereof is preferably 4 to 15% by weight based on the cerium-zirconium-rare earth metal mixed oxide. If the cerium-zirconium-rare earth metal mixed oxides contain praseodymium oxide as a rare earth metal, the proportion thereof is preferably 2 to 10% by weight based on the cerium-zirconium-rare earth metal mixed oxide. If the cerium-zirconium-rare earth metal mixed oxides contain lanthanum oxide and a further rare earth oxide as a rare earth metal, such as yttrium oxide or praseodymium oxide, the mass ratio thereof is in particular 0.1 to 1.25, preferably 0.1 to 1.

The coating Z usually contains oxygen storage components in quantities of 15 to 120 g/l, based on the volume of the wall-flow filter substrate. The mass ratio of carrier materials and oxygen storage components in the coating Z is usually 0.25 to 1.5, for example 0.3 to 1.3.

For example, the weight ratio of the sum of the masses of all aluminum oxides (including doped aluminum oxides) to the sum of the masses of all cerium-zirconium mixed oxides in coating Z is 10:90 to 75:25.

In embodiments of the present invention, the coating Z comprises lanthanum-stabilized aluminum oxide, rhodium, palladium or palladium and rhodium, and a cerium-zirconium-rare earth metal mixed oxide containing yttrium oxide and lanthanum oxide as rare earth metal oxides.

In other embodiments of the present invention, the coating Z comprises lanthanum-stabilized aluminum oxide, rhodium, palladium or palladium and rhodium, and a cerium-zirconium-rare earth metal mixed oxide containing praseodymium oxide and lanthanum oxide as rare earth metal oxides.

In other embodiments of the present invention, the coating Z comprises lanthanum-stabilized aluminum oxide, rhodium, palladium, or palladium and rhodium, a cerium-zirconium-rare earth metal mixed oxide containing praseodymium oxide and lanthanum oxide as rare earth metal oxides, and a second cerium-zirconium-rare earth metal mixed oxide containing yttrium oxide and lanthanum oxide as rare earth metal oxides.

The coating Z preferably does not contain a zeolite or a molecular sieve.

In embodiments of the present invention in which coating Z contains aluminum oxide or doped aluminum oxide, the weight ratio of the sum of the masses of all aluminum oxides or doped aluminum oxides to the sum of the masses of all cerium-zirconium mixed oxides or cerium-zirconium-rare earth metal mixed oxides is in particular 10:90 to 75:25.

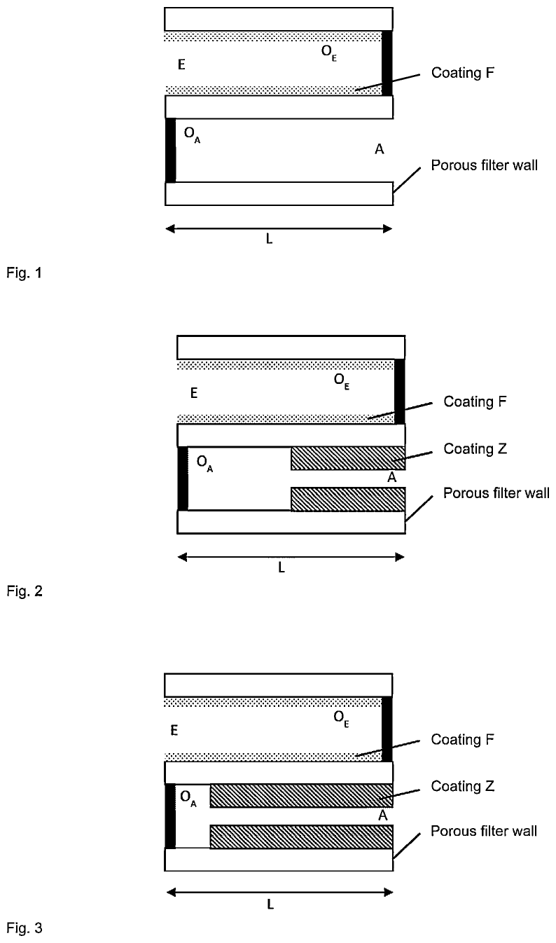

The coatings F and can be arranged on the wall-flow filter substrate in various ways. FIG. 1 to 5 illustrate this by way of example.

FIG. 1 relates to a wall-flow filter according to the invention in which the coating F is located in the channels E and extends over the entire length L. Coating Z is not present.

FIG. 2 relates to a wall-flow filter according to the invention in which the coating Z is located in the channels A on the surfaces O_{A} and extends from the second end of the wall-flow filter substrate to 50% of the length L. The coating F is located in the channels E and extends over the entire length L.

FIG. 3 also relates to a wall-flow filter according to the invention in which the coating Z is located in the channels A on the surfaces O_{A}. Starting from the second end of the wall-flow filter substrate, however, it extends over 80% of the length L. The coating F is located in the channels E and extends over the entire length L.

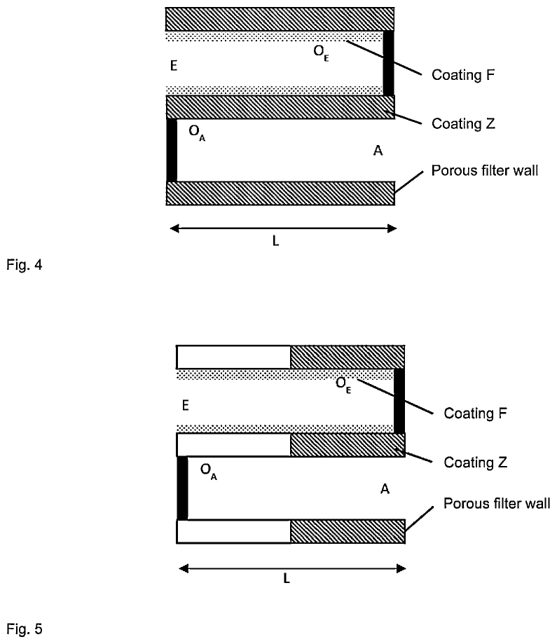

FIG. 4 relates to a wall-flow filter according to the invention in which the coating Z is located in the porous walls and extends over the entire length L. The coating F is located in the channels E and likewise extends over the entire length L.

FIG. 5 relates to a wall-flow filter according to the invention in which the coating Z is located in the porous walls and extends from the second end of the wall-flow filter substrate to 50% of the length L. The coating F is located in the channels E and extends over the entire length L.

The wall-flow filter according to the invention can be produced by applying the coatings F and, if present, Z to a wall-flow filter substrate.

If present, the coating Z by a typical coating method, in particular by applying a correspondingly aqueous suspension of the catalytically active components, also referred to as a washcoat, into or onto the wall of the wall-flow filter substrate, for example in accordance with EP1789190B1. After application of the suspension, the wall-flow filter substrate is dried and, if applicable, calcined at an increased temperature. The catalytically coated filter preferably has a coating Z loading of 20 g/l to 200 g/l, preferably 30 g/l to 150 g/l. The most suitable amount of loading of a wall-coated filter coated depends on its cell density, its wall thickness, and the porosity.

The coating F is applied to the wall-flow filter substrate in particular by applying a dry powder-gas aerosol to the channels E of the dry wall-flow filter substrate optionally already coated with coating Z, wherein the powder contains a particulate metal compound which catalyzes the oxidation of soot. According to the invention, the coating F is also applied by means of an aqueous suspension, for example according to EP1789190B1.

By applying a dry powder-gas aerosol to a wall-flow filter substrate which has been wet-coated in a conventional manner with coating Z, dried and optionally calcined, a wall-flow filter according to the invention is obtained which has extremely good filtration efficiency and only slightly increased exhaust gas counterpressure and, at the same time, excellent catalytic efficiency.

The wall-flow filters which are catalytically coated according to the invention and then impinged on by powder, differ from those that are produced in the exhaust system of a vehicle by ash deposition during operation. According to the invention, the catalytically active wall-flow filter substrates are selectively powder-sprayed with a specific, dry powder. As a result, the balance between filtration efficiency and exhaust-gas back pressure can be adjusted selectively right from the start. Wall-flow filters in which undefined ash deposits have resulted from combustion of fuel, e.g., in the cylinder during driving operation or by means of a burner, are therefore not included in the present invention.

When the dry powder-gas aerosol is impinged on the wall-flow filter substrates considered here, the powder particles are deposited in the pores of the wall-flow filter substrate and, optionally, on the surfaces O_{E} following the flow of the gas. In the process, the different wall permeability of the wall-flow filter substrate (e.g., due to inhomogeneities of the filter wall itself or different coating zones) leads to selective deposition of the powder in the pores of the wall or on the surfaces O_{E} where the flow is the greatest. This effect also results in, for example, cracks or pores in the washcoat layer being filled up by the porous powder due to coating defects, such that the soot particles in the exhaust gas are later increasingly retained as the exhaust gas passes through the filter. A better filtration efficiency is consequently the result.

According to the invention, the dry wall-flow filter substrate coated with coating Z is covered with a powder starting from its first end and in the direction of its second end (i.e., with respect to the intended use in the direction of exhaust gas flow) in such a way that the cell wall regions through which the flow is strongest are covered with loose, inherently porous powder accumulations in the porous walls and/or also on the surfaces O_{E} in order to obtain the desired increased filtration efficiency. In the process, the formation of the intrinsically porous powder accumulations surprisingly leads to a relatively low increase in back pressure. In a preferred embodiment, the wall-flow filter substrate is impinged with a powder-gas aerosol in such a way that during impingement, the powder is deposited in the pores of the porous wall and on the surfaces O_{E} and builds up a cohesive layer here. In a further most preferred embodiment, the wall-flow filter is impinged with a powder-gas aerosol such that during impingement, the powder precipitates in the pores of the filter walls and fills them as far as the surfaces O_{E} and thereby does not form a cohesive layer on surfaces O_{E}.

In order for the powder of the powder-gas aerosol to deposit sufficiently well in the pores of the wall-flow filter substrate coated with coating Z or to adhere to the surfaces O_{E}, the particle diameter in the aerosol should at least be smaller than the pores of the wall-flow filter substrate. This can be expressed by the relationship between the average particle diameter (Q₃ distribution, measured according to the most recent ISO 13320 on the date of application) d50 in the dry aerosol and the average pore diameter of the wall-flow filter after coating (measured according to DIN 66134, latest version on the date of application) being between 0.03-2, preferably between 0.05-1.43 and very particularly preferably between 0.05-0.63. As a result, the particles of the powder in the aerosol, following the gas flow, can precipitate in the pores of the walls of the wall-flow filter substrate. A suitable powder has in particular a specific surface area of at least 100 m²/g and a total pore volume of at least 0.3 ml/g.

For a powder suitable for producing the wall-flow filters according to the invention, an optimization between the largest possible surface area of the powder used, the crosslinking, and the adhesive strength is advantageous. During operation in the vehicle, small particles follow the flow lines approximately without inertia due to their low particle relaxation time. A random “trembling movement” is superimposed on this uniform, convection-driven movement. Following this theory, the largest possible flowed-around surfaces should be provided for a good filtration effect of a wall-flow filter impinged on by powder. The powder should therefore have a high proportion of fines, since with the same total volume of metal compound, small particles offer significantly larger surfaces. At the same time, however, the pressure loss must only increase insignificantly. This requires a loose crosslinking of the powder. For a filtration efficiency-enhancing coating, it is preferable to use powders having a tapped density of between 50 g/l and 900 g/l, preferably between 200 g/l and 850 g/l and most preferably between 400 g/l and 800 g/l.

The aerosol consisting of the gas and the powder may be produced in accordance with the requirements of the person skilled in the art or as illustrated below. For this purpose, a powder is usually mixed with a gas (http://www.tsi.com/Aerosolgeneratoren-und-dispergierer/; https://www.palas.de/de/product/aerosolgeneratorssolidparticles). This mixture of gas and powder produced in this way is then advantageously fed into the channels E of the wall-flow filter substrate via a gas stream.

All gases considered by the person skilled in the art for the present purpose can be used as gases for producing the aerosol and for introduction into the wall-flow filter substrate. The use of air is very particularly preferred. However, it is also possible to use other reaction gases which can develop either an oxidizing (e.g., O₂, NO₂) or a reducing (e.g., H₂) activity with respect to the powder used. With certain powders, the use of inert gases (e.g., N₂) or noble gases (e.g., He) may also prove advantageous. Mixtures of the listed gases are also conceivable.

In order to be able to deposit the powder to a sufficient depth into the channels E and with good adhesion, a certain suction power is needed. In orientation experiments for the respective wall-flow filter and the respective powder, the person skilled in the art can form their own idea in this respect. It has been found that the aerosol (powder-gas mixture) is preferably sucked through the wall-flow filter at a velocity of 5 m/s to 60 m/s, more preferably 10 m/s to 50 m/s, and very particularly preferably 15 m/s to 40 m/s. This likewise achieves an advantageous adhesion of the applied powder.

Dispersion of the powder in the gas for establishing a powder-gas aerosol takes place in various ways. The dispersion of the powder is preferably generated by at least one or a combination of the following measures: compressed air, ultrasound, screening, “in situ grinding”, blower, expansion of gases, fluidized bed. Further dispersion methods not mentioned here can likewise be used by the person skilled in the art. In principle, the person skilled in the art is free to select a method for producing the powder-gas aerosol. As already described, the powder is first converted by dispersion into a powder-gas aerosol and then guided into a gas stream.

This mixture of the gas and the powder thus produced is only subsequently introduced into an existing gas stream, which carries the finely distributed powder into the channels E of the wall-flow filter substrate. This process is preferably assisted by a suction device which is positioned in the pipeline on the outflow side of the filter. This is in contrast to the device shown in FIG. 3 of U.S. Pat. No. 8,277,880B, in which the powder-gas aerosol is produced directly in the gas stream. The method according to the invention allows a much more uniform and good mixing of the gas stream with the powder-gas aerosol, which ultimately ensures an advantageous distribution of the powder particles in the filter in the radial and axial direction and thus helps to make uniform and control the deposition of the powder particles on the filter.

The powder is dry when the wall-flow filter substrate is impinged on in the sense of the invention. The powder is preferably mixed with ambient air and applied to the filter. By mixing the powder-gas aerosol with particle-free gas, preferably dry ambient air, the concentration of the particles is reduced to such an extent that no appreciable agglomeration takes place until deposition in the wall-flow filter substrate. This preserves the particle size in the aerosol adjusted during the dispersion.

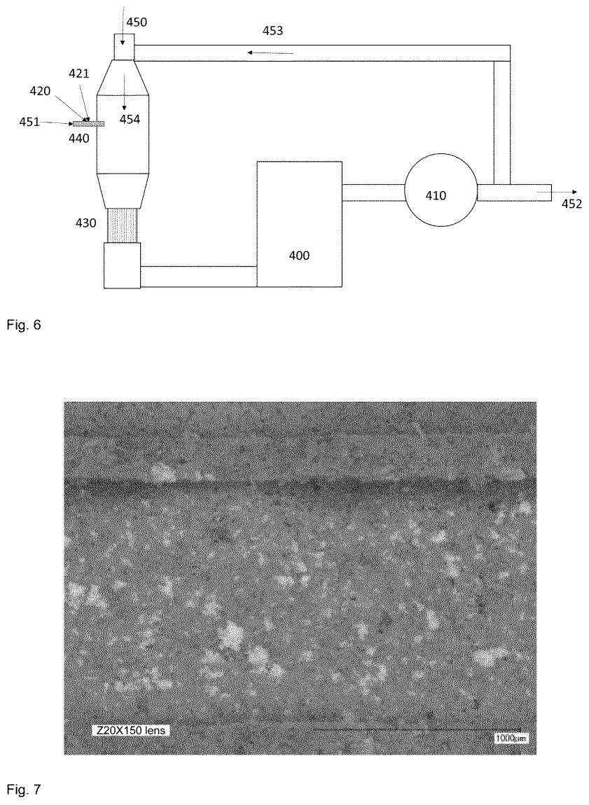

A preferred device for producing a wall-flow filter according to the invention is shown schematically in FIG. 6. Such a device is characterized in that
at least one unit for dispersing powder in a gas;
a unit for mixing the dispersion with an existing gas stream;
at least two filter-receiving units designed to allow the gas stream to flow through the filter without further supply of a gas;
a suction-generating unit that maintains the gas stream through the filter;
optionally, a unit for generating vortices upstream of the filter so that deposition of powder on the inlet plugs of the filter is prevented as much as possible;
and optionally, a unit by which at least one partial gas stream is extracted from the outflow side of the suction device and, before the powder addition, is added to the gas stream which is sucked through the filter;
   are present.

In this preferred embodiment of the method according to the invention, as shown in the outline in FIG. 6, at least a partial gas stream is extracted from the outflow side of the suction device and added, before the powder addition, back to the gas stream that is drawn through the filter. The powder is thereby metered into an already heated air stream. The suction blowers for the necessary pressures generate approximately 70° C. exhaust air temperature since the installed suction power is preferably >20 kW. In an energetically optimized manner, the waste heat of the suction blower is used to heat the supply air in order to reduce the relative humidity of the supply air. This in turn reduces the adhesion of the particles to one another and to the input plugs. The deposition process of the powder can thus be better controlled.

In the present method for producing a wall-flow filter according to the invention, a gas stream is impinged on by a powder-gas aerosol and sucked into a wall-flow filter substrate. This ensures that the powder can be distributed sufficiently well in the gas stream for it to be able to penetrate into the channels E. Homogeneous distribution of the powder in the gas/air requires intensive mixing. For this purpose, diffusers, venturi mixers, and static mixers are known to the person skilled in the art. Particularly suitable for the powder coating process are mixing devices that avoid powder deposits on the surfaces of the coating system. Diffusers and venturi tubes are thus preferably used for this process. The introduction of the dispersed powder into a fast-rotating rotating flow with a high turbulence has also proven effective.

In order to achieve an advantageous uniform distribution of the powder over the cross section of the wall-flow filter substrate, the gas transporting the powder should have a piston flow (if possible, the same velocity over the cross section) when impinging on the filter. This is preferably adjusted by an accelerated flow upstream of the filter. As is known to the person skilled in the art, a continuous reduction of the cross section without abrupt changes causes such an accelerated flow, described by the continuity equation. Furthermore, it is also known to the person skilled in the art that the flow profile is thus more closely approximated to a piston profile. For the targeted change of the flow, built-in components, such as sieves, rings, disks, etc., can be used below and/or above the filter.

In a further advantageous design of the present method, the apparatus for powder coating has one or more devices (turbulators, vortex generators) with which the gas stream carrying the powder-gas aerosol can be vortexed prior to impingement on the filter. As an example in this respect, corresponding sieves or grids can be used which are placed at a sufficient distance on the inflow side of the wall-flow filter substrate. The distance should not be too large or small so that sufficient vortexing of the gas stream directly upstream of the wall-flow filter substrate is achieved. The person skilled in the art can determine the distance in simple experiments. The advantage of this measure is explained by the fact that powder constituents do not deposit on the plugs of the channels A and all the powder can penetrate into the channels E. Accordingly, it is preferred according to the invention if the powder is vortexed before flowing into the filter in such a way that deposits of powder on the plugs of the wall-flow filter substrate are avoided as far as possible. A turbulator or turbulence generator or vortex generator in aerodynamics refers to equipment which causes an artificial disturbance of the flow. As is known to the person skilled in the art, vortices (in particular microvortices) form behind rods, gratings, and other flow-interfering built-in components at corresponding Re numbers. Known are the Karman vortex street (H. Benard, C. R. Acad. Sci. Paris. Ser. IV 147, 839 (1908); 147, 970 (1908); T. von Karman, Nachr. Ges. Wiss. Göttingen, Math. Phys. KI. 509 (1911); 547 (1912)) and the wake turbulence behind airplanes which can cover roofs. In the case according to the invention, this effect can be intensified very particularly advantageously by vibrating self-cleaning sieves (so-called ultrasonic screens) which advantageously move in the flow. Another method is the disturbance of the flow through sound fields, which excites the flow to turbulences as a result of the pressure amplitudes. These sound fields can even clean the surface of the filter without flow. The frequencies may range from ultrasound to infrasound. The latter measures are also used for pipe cleaning in large-scale technical plants.

The preferred embodiments for the wall-flow filter apply mutatis mutandis also to the method. Reference is explicitly made in this respect to what was said above about the wall-flow filter.

Dry in the sense of the present invention means exclusion of the application of a liquid, in particular water. In particular, the production of a suspension of the powder in a liquid for spraying into a gas stream should be avoided. A certain moisture content may possibly be tolerable both for the filter and for the powder, provided that achieving the objective, i.e., the most finely distributed deposition of the powder in the porous walls and/or the surfaces O_{E} of the wall-flow filter substrate possible, is not negatively affected. As a rule, the powder is free-flowing and dispersible by energy input. The moisture content of the powder or of the wall-flow filter substrate at the time of being impinged on by the powder should be less than 20%, preferably less than 10%, and very particularly preferably less than 5% (measured at 20° C. and normal pressure, ISO 11465, latest version on the filing date).

The wall-flow filter according to the invention exhibits an excellent filtration efficiency with only a moderate increase in exhaust-gas back pressure as compared to a wall-flow filter in the fresh state that has not been impinged on by powder. The wall-flow filter according to the invention preferably exhibits an improvement in soot particle deposition (filtering effect) in the filter of at least 5%, preferably at least 10% and very particularly preferably at least 20% at a relative increase in the exhaust-gas back pressure of the fresh wall-flow filter of at most 40%, preferably at most 20% and very particularly preferably at most 10% as compared to a fresh filter coated with catalytically active material but not treated with powder. The slight increase in back pressure is probably due to the cross section of the channels on the input side not being significantly reduced by impinging, according to the invention, the filter with a powder. It is assumed that the powder in itself forms a porous structure, which has a positive effect on the back pressure. For this reason, a wall-flow filter according to the invention should also exhibit better exhaust-gas back pressure than those of the prior art, with which a powder was deposited on the walls of the inlet side of a filter or a traditional coating using wet techniques was chosen.

Coating F can also reduce the soot ignition temperature and thus catalyze the oxidation of soot. Coating Z confers excellent three-way activity on the wall-flow filter according to the invention.

The present invention thus also relates to the use of a wall-flow filter according to the invention for reducing harmful exhaust gases of an internal combustion engine. The use of the wall-flow filter according to the invention for treating exhaust gases of a stoichiometrically operated internal combustion engine, i.e. in particular a gasoline-operated internal combustion engine, is preferred.

The wall-flow filter according to the invention is very advantageously used in combination with at least one three-way catalyst. In particular, it is advantageous if a three-way catalyst is located in a position close to the engine on the inflow side of the wall-flow filter according to the invention. It is also advantageous if a three-way catalyst is located on the outflow side of the wall-flow filter according to the invention. It is also advantageous if a three-way catalyst is located on the inflow side and on the outflow side of the wall-flow filter.

The preferred embodiments described for the wall-flow filter according to the invention also apply mutatis mutandis to the use mentioned here.

The requirements applicable to gasoline particulate filters (GPF) differ significantly from the requirements applicable to diesel particulate filters (DPF). Diesel engines without DPF can have up to ten times higher particle emissions, based on the particle mass, than gasoline engines without GPF (Maricq et al., SAE 1999-01-01530). In addition, there are significantly fewer primary particles in the case of gasoline engines, and the secondary particles (agglomerates) are significantly smaller than in diesel engines. Emissions from gasoline engines range from particle sizes of less than 200 nm (Hall et al., SAE 1999-01-3530) to 400 nm (Mathis et al., Atmospheric Environment 38 4347) with a maximum in the range of around 60 nm to 80 nm. For this reason, the nanoparticles in the case of GPF must mainly be filtered by diffusion separation. For particles smaller than 300 nm, separation by diffusion (Brownian molecular motion) and electrostatic forces becomes more and more important with decreasing size (Hinds, W.: Aerosol technology: Properties and behavior and measurement of airborne particles. Wiley, 2nd edition 1999).

FIG. 1 to 5 show the different coating arrangements of wall-flow filters according to the invention, which are already described in more detail above. The following designations are used therein:
(E) the inlet channel/inflow channel of the wall-flow filter
(A) the outlet channel/outflow channel of the wall-flow filter
(O_{E}) the surfaces formed by the inlet channels (E)
(O_{A}) the surfaces formed by the outlet channels (A)
(L) the length of the filter wall
(Z) the coating Z
(F) the coating F.

FIG. 6 shows a schematic drawing of an advantageous device for applying a powder to the filters. The powder 420 or 421 is mixed with the gas under pressure 451 through the atomizer nozzle 440 in the mixing chamber with the gas stream 454 and then is sucked or pushed through the filter 430. The particles that have penetrated are filtered out in the exhaust filter 400. The blower 410 provides the necessary volumetric flow. The exhaust gas is divided into an exhaust 452 and a warm cycle gas 453. The warm cycle gas 453 is mixed with the fresh gas 450.

FIG. 7 shows an image produced by light microscopy of a wall-flow filter to which powder is applied. The photograph shows a top view of a plurality of channel walls in a region of the wall-flow filter where no catalytically active on-wall layer is located. The powder is selectively deposited in the pores of the wall and fills them.

The invention described will be explained in more detail in the following section with reference to examples.

### COMPARATIVE EXAMPLE 1

A commercially available ceramic filter substrate consisting of cordierite, having the dimensions 4.66″×4.66″×6.00″ and having a cell density of 300 cells per square inch and a wall thickness of 8.5 mil (approximately 216 μm) is used as a reference for all subsequent filters according to the invention, and is referred to below as vGPF1. vGFP1 typically has a porosity of approx. 65% and an average pore size distribution d50 of 18 μm.

### EXAMPLE 1 ACCORDING TO THE INVENTION

A filter substrate as described in Comparative Example 1 was coated with pure cerium oxide by methods known to a person skilled in the art and then dried and calcined. In the fresh state, the cerium oxide used has a specific surface area of 100-160 m2/g. After coating, the filter load was 50 g/L. This is referred to below as GPF1.

The two filters vGPF1 and GPF1 were then sooted on the engine test bench. In this case, both filters were loaded with about 5 g of soot. Thereafter, the soot was burned off at an exhaust gas temperature of 500° C. and an engine lambda of λ=1.1. The time after which the counterpressure, which was increased relative to the fresh filter by the soot loading, reduced to half the soot-induced counterpressure increase served as a measure of the burn-off rate. The filter GPF1 according to the invention was able to halve the counterpressure increase caused by the soot loading after 4100 seconds, while the commercially available ceramic filter substrate only had a reduction in the soot counterpressure of 10% after over 8000 seconds. It can thus be seen that the filter GPF1 according to the invention catalyzes the soot oxidation with respect to the commercially available ceramic filter substrate and thus enables accelerated regeneration of the particle filter.

Following the experiments described, the cerium oxide used for coating the GPF1 according to the invention was used as a reference material for a further material study. After the materials in question were first aged in a hydrothermal aging process at 800° C. for 16 h with 10% H2O, the cerium oxide and further metal oxides were initially each mixed with commercially available industrial soot (Printex U by Orion). The weight ratio of soot to metal oxide was 1:4. The soot-metal oxide mixture was then heated in a thermogravimetric analysis method to a temperature of 800° C. under atmospheric conditions at a rate of 10° C./min, and the mass loss of the sample was determined. The mass loss observed in this case corresponds to the amount of soot oxidized to CO₂. The T50 value, i.e., the temperature at which the sample had lost 50% of the weighed-in soot mass, served here as a base variable. In order to control and validate the experiments, blank measurements were always carried out without soot. In addition, the described experiment was carried out at least twice for each metal compound in order to increase the significance. The following compounds were investigated here and compared to the cerium oxide used in Example 1 according to the invention. The results are summarized in Table 1.

TABLE 1
T50 values in the TGA experiment for various particulate compounds
after hydrothermal aging at 800° C. for 16 h with 10% H2O.

| Material/composition | T50 [° C.] at TGA Test |
|---|---|
| CeO2 | 575 |
| SiO2 | 590 |
| Ce0•5Zr0•5O2 | 554 |
| Mn2Fe4Ce34Pr15Zr45Ox | 531 |
| Ce0•5Pr0•5O2-x | 502 |
| Mn0•1Ce0•45Pr0•45O2-x | 484 |

The results show that, in addition to the cerium oxide used in Example 1, further compounds exist which catalyze the soot oxidation and thus can be considered for the use according to the invention for coating F.

1. A wall-flow filter for removing particles from the exhaust gas of internal combustion engines, comprising a wall-flow filter substrate of length L and a coating F,
the wall-flow filter substrate having channels E and A, which extend in parallel between a first and a second end of the wall-flow filter substrate, are separated by porous walls and form surfaces O_{E} and O_{A} respectively, and channels E being closed at the second end and channels A being closed at the first end,
and the coating F being located in the porous walls and/or on the surfaces O_{E}, but not on the surfaces O_{A}, and comprising a particulate metal compound and no noble metal,
characterized in that the particulate metal compound catalyzes the oxidation of soot, and the particulate metal compound is a mixed oxide and, in addition to cerium, contains at least one further metal from the group of manganese and praseodymium, and preferably a greater amount of coating F is located in the vicinity of the second end of the wall-flow filter substrate and a significantly smaller amount of the coating F is located in the vicinity of the first end of the wall-flow filter substrate.

2.-6. (canceled)

7. The wall-flow filter according to claim 1, characterized in that said filter has an increasing concentration gradient of the coating F in the longitudinal direction of the filter from its first to its second end.

8. The wall-flow filter according to claim 1, characterized in that the wall-flow filter substrate has a coating Z which is located in the porous walls and/or on the surfaces O_{A} but not on the surfaces O_{E} and comprises palladium and/or rhodium and a cerium-zirconium mixed oxide.

9. The wall-flow filter according to claim 8, characterized in that coating Z is located on the surfaces O_{A} of the wall-flow filter substrate and extends from the second end of the wall-flow filter substrate to 50 to 90% of the length L.

10. The wall-flow filter according to claim 8, characterized in that coating Z is located in the porous walls of the wall-flow filter substrate and extends from the first end of the wall-flow filter substrate to 50 to 100% of the length L.

11. The wall-flow filter according to claim 8, characterized in that coating Z contains palladium and rhodium and no platinum.

12. The wall-flow filter according to claim 8, characterized in that the cerium-zirconium mixed oxide of coating Z contains one or more rare earth metal oxides.

13. The wall-flow filter according to claim 12, characterized in that the rare earth metal oxide is lanthanum oxide, yttrium oxide, praseodymium oxide, neodymium oxide and/or samarium oxide.

14. The wall-flow filter according to claim 8, characterized in that coating Z comprises lanthanum-stabilized aluminum oxide, rhodium, palladium or palladium and rhodium, and a cerium-zirconium-rare earth metal mixed oxide containing yttrium oxide and lanthanum oxide as rare earth metal oxides.

15. The wall-flow filter according to claim 8, characterized in that coating Z comprises lanthanum-stabilized aluminum oxide, rhodium, palladium or palladium and rhodium, and a cerium-zirconium-rare earth metal mixed oxide containing praseodymium oxide and lanthanum oxide as rare earth metal oxides.

16. A method for producing a wall-flow filter according to claim 1, characterized in that a dry powder-gas aerosol is applied to the channels E of the dry wall-flow filter substrate optionally already coated with coating Z, the powder containing a particulate metal compound which catalyzes the oxidation of soot.

17. Use of a wall-flow filter according to claim 1 for reducing harmful exhaust gases of an internal combustion engine.
